(19) United States
(12) Patent Application Publication
(10) Pub. No.: US 2005/0244667 A1
(43) Pub. Date: Nov. 3, 2005

(54) Hybrid-produced sheet metal element and method of producing same

(76) Inventor: Andreas Hauger, (US)

Correspondence Address: Wyatt, Gerber & O'Rourke, LLP, 99 Park Avenue, New York, NY, 10016, US

(21) Appl. No.: 11/109,111

(22) Filed: Apr. 19, 2005

(30) Foreign Application Priority Data
Apr. 19, 2004 (DE) 10 2004 019 448.3

(51) Int. Cl. B32B 3/00

(52) U.S. Cl. 428/600

(57) ABSTRACT

A sheet metal element in the form of a semi-finished product is produced by joining at least one part consisting of flexibly rolled sheet metal whose sheet thickness is variable along the rolling direction and at least one part consisting of a rolled sheet metal with a constant sheet thickness.

The invention relates to sheet metal elements produced by joining a plurality of parts, more particularly in the form of semi-finished products which are subsequently deformed for the purpose of being used as profiles or metal sheets in motor vehicle bodies.

### BACKGROUND AND OBJECTIVE OF THE INVENTION

It is known to butt-weld metal sheets of different thicknesses for such applications in order to produce profiles or sheet bar with stepped strength characteristics. Stepped strength characteristics are frequently required in connection with the crash behavior of special motor vehicle body parts.

It is the object of the present invention to provide sheet metal elements which are produced in a cost-effective way and which comprise differentiated strength characteristics inside the sheet metal elements.

### SUMMARY OF THE INVENTION

The objective is achieved by means of a sheet metal element which is produced by joining at least one part consisting of flexibly rolled sheet metal whose sheet thickness varies along the rolling direction and at least one part of rolled sheet metal with a constant sheet thickness. A further solution consists in providing a sheet metal element which is produced by joining at least two parts consisting of flexibly rolled sheet metal. In a preferred embodiment, at least partially different sheet thicknesses can meet at the joint. In this way, it is possible to achieve variations in thickness which cannot be achieved or only at great expense by welding together individual sheets and which cannot be achieved in the required dimensions by flexible rolling only. More particularly, it is advantageous to form large sheet metal regions in the same thickness from uniformly rolled standard sheet metal with a constant sheet thickness and to produce only regions with gently varying sheet thicknesses from flexibly rolled sheet metal whose sheet thickness varies in the rolling direction.

According to a first alternative, it is possible for the joint to extend substantially parallel to the rolling direction along which the sheet thickness changes in the flexibly rolled material. It can be seen that a sheet metal element with such a structure, if produced by welding individual elements only, can only be achieved at great expense, and in most such cases, it would be necessary to produce welds along two axes arranged perpendicularly relative to one another.

According to a second alternative it is proposed that the joint extend substantially transversely to the rolling direction along which the sheet thickness changes within the flexibly rolled material. In this case, joints are obtained wherein the parts to be joined comprise a constant sheet thickness.

According to as special embodiment, an inventive sheet metal element comprises a plurality of joints which preferably extend parallel relative to one another. According to a first variation it is proposed that a part consisting of flexibly rolled sheet metal be positioned between two parts consisting of sheet metal with a constant thickness. It is also possible for a sheet metal part with a constant thickness to be arranged between two parts consisting of flexibly rolled sheet metal. In a preferred embodiment, it is possible to provide a symmetry of sheet metal thickness along a central axis.

Joining can preferably be carried out by welding, with the joint being butt-welds or with the parts overlapping. Use can be made of prior art welding methods such as laser welding, magnetic arc welding, etc. According to alternatives, it is also possible for the individual parts to be clinched or riveted in an overlapping condition or for the individual parts to be glued so as to overlap one another. Finally, it is possible for the individual parts to be connected to one another by a crimping process.

### SUMMARY OF METHODS USED FOR INVENTION

Below, there will follow a description of particularly advantageous methods of producing sheet metal elements in accordance with the invention.

A first method of producing inventive sheet metal elements is characterized in that at least one strip of flexibly rolled sheet metal whose sheet thickness varies along the rolling direction A and one strip of rolled sheet metal with a constant sheet thickness are continuously joined parallel to the rolling direction to form a strip. Subsequently, sheet metal elements consisting of at least one part of flexibly rolled strip and at least one part of sheet metal with a constant sheet thickness are separated. An alternative method of producing inventive sheet metal elements is characterized in that at least two strips of flexibly rolled sheet metal whose sheet thickness varies along the rolling direction A₁, A₂ are joined parallel to the rolling direction to form a strip. Subsequently sheet metal elements consisting of at least two different parts are separated from the strip, wherein, preferably, the strips are joined in such a way that different sheet thicknesses meet in the joint. Two strip rolls (coils) consisting of flexibly rolled strip and of strip with a constant sheet thickness and two coils consisting of flexibly rolled strip with thickness sequences which deviate from one another are unwound synchronously and guided together in such a way that they can be joined along their longitudinal edges. This process can also be repeated several times. It is only then that individual parts are separated form the strip. The individual parts comprise sheet thickness structures which are almost impossible to produce in any other way. For example, it is possible to combine continuous edge regions with a greater thickness with inner regions of a lesser sheet thickness. The joined strip can first be coiled again and, in further treatment stages, it can be subjected to a heat treatment and surface treatment, and it is only thereafter that the individual sheet metal elements have to be separated.

A third method is characterized in that parts consisting of flexibly rolled sheet metal whose sheet thickness varies along the rolling direction A and parts consisting of rolled sheet metal with a constant sheet thickness are alternately continuously joined transversely to the rolling direction to form a strip. Subsequently sheet metal elements consisting of at least one part of flexibly rolled sheet metal and at least one part of sheet metal with a constant sheet thickness are separated. The strip initially formed in this way comprises stepped thicknesses transversely to the longitudinal direction of the strip only and thus resembles a flexibly rolled strip. However, because of the joining operation, it is possible to achieve a greater sheet thickness spread than can be achieved by flexible rolling on its own. This means that, first, individual parts are separated from flexibly rolled strips and/or strips rolled with a constant sheet thickness, which individual parts then, in an alternating sequence, are joined to form a strip which can undergo further treatment stages which can most advantageously be carried out on coils. More particularly, these treatment stages consist of heat treatment and surface treatment. It is only after these treatment stages have been carried out that the strip is divided in such a way that there is obtained individual sheet metal elements produced by joining at least two differently rolled parts.

### BRIEF DESCRIPTION OF THE DRAWINGS

Preferred embodiments of the invention are illustrated in the drawings described hereinafter:

FIG. 1a illustrates a sheet metal element in a plan view which is produced by joining two parts one of which consists of a flexibly rolled sheet metal

FIG. 1b is a cross-section of the sheet metal element of FIG. 1a

FIG. 2a illustrates a sheet metal element in a plan view which is produced by jointing three parts of which the central one consists of flexibly rolled sheet metal

FIG. 2b is a cross-section of the sheet metal element of FIG. 2a.

FIG. 3a illustrates a sheet metal element in a plan view which is produced by jointing three parts of which the outer ones consist of flexibly rolled sheet metal

FIG. 3b is a cross-section of the sheet metal element of FIG. 3a

FIG. 4a illustrates a sheet metal element in a plan view which is produced by joining two parts which both consist of flexibly rolled sheet metal

FIG. 4b is a cross-section of the sheet metal element of FIG. 4a

FIG. 5a illustrates a sheet metal element in a plan view which is produced by joining two parts of which one consists of flexibly rolled sheet metal, with the joint extending transversely to the rolling direction

FIG. 5b is a cross-section of the sheet metal element of FIG. 5a

FIG. 6a illustrates a sheet metal element in a plan view which is produced by joining three parts of which the outer ones consist of flexibly rolled sheet metal, with the joints extending transversely to the rolling direction

FIG. 7a illustrates a sheet metal element in a plan view which is produced by joining three parts of which the central one consists of flexibly rolled sheet metal, with the joints extending transversely to the rolling direction.

FIG. 7b is a cross-section of the sheet metal element of FIG. 7a

### DETAILED DESCRIPTION OF THE INVENTION

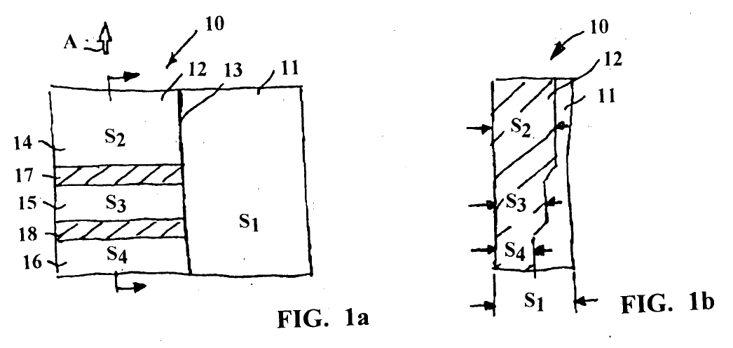

FIGS. 1a and 1b show an inventive sheet metal element 10 which is produced by joining a metal sheet 11 with a constant thickness S₁ and a flexibly rolled metal sheet 12. The joint is shown to be a weld 13. In the rolling direction A, the flexibly rolled metal sheet 12 comprises three regions 14, 15, 16 which are positioned one behind the other and which comprise a decreasing thickness S₂, S₃, S₄, with the regions of transition 17, 18 being hatched in the plan view.

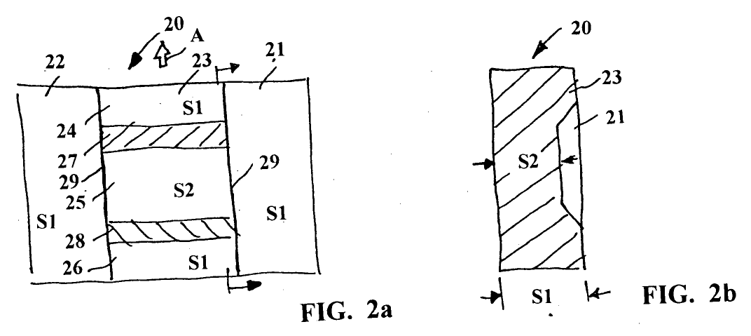

FIGS. 2a and 2b show an inventive sheet metal element 20 which consists of two outer parts 21, 22 with a constant thickness S₁ and of one flexibly rolled part 23 with three portions 24, 25 26 with different thicknesses S₁, S₂. The thicknesses change in the rolling direction A. The regions of transition 27, 28 are hatched in the plan view. The joints are provided in the form of welds 29. There is thus formed a substantially dish-shaped part with a reduced central thickness S₂; the portion 25 can be larger relative to the portions 21, 22, 23, 26 than shown here.

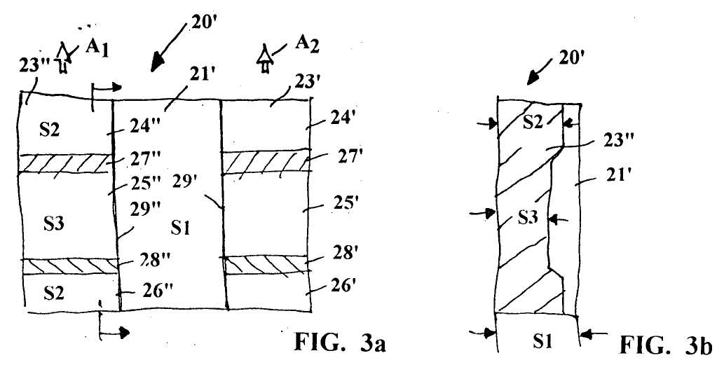

FIGS. 3a and 3b show an inventive sheet metal element 20′ which is produced by joining a central portion 21′ with a constant thickness S₁ and two outer parts 23′, 23″ consisting of flexibly rolled sheet metal with rolling directions A₁, A₂. The outer parts each comprise three portions 24′, 25′, 26′, 24″, 25″, 26″ with different thicknesses S₂, S₃, with the regions of transition 27′, 28′, 27″, 28″ being hatched in the plan view. The joints are provided in the form of welds 29′, 29″.

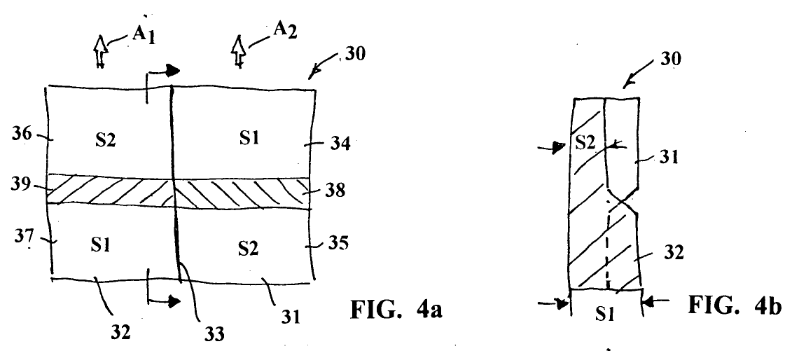

FIGS. 4a and 4b show an inventive sheet metal element 30 which is produced by joining two parts 31, 32 consisting of flexibly rolled sheet metal, with the parts each comprising portions 34, 35, 36, 37 of different thicknesses S₁, S₂. The regions of transition 38, 39 are hatched in the plan view. The joint extending parallel to the rolling directions A₁, A₂ is provided in the form of a weld 33. The parts 31, 32 are joined in such a way that mostly different sheet thicknesses abut at the weld.

With all embodiments according to FIGS. 1 to 4, it is possible, initially, to produce, by joining, the strip from two rolled strips with the joint in the rolling direction and then separating individual parts 10, 20 30 transversely to the rolling direction, if necessary, by putting up with waste.

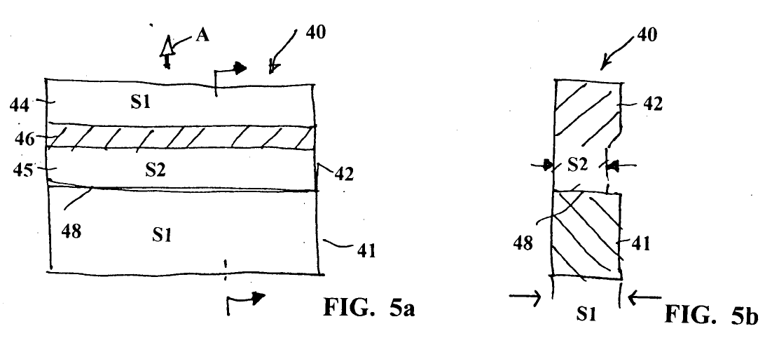

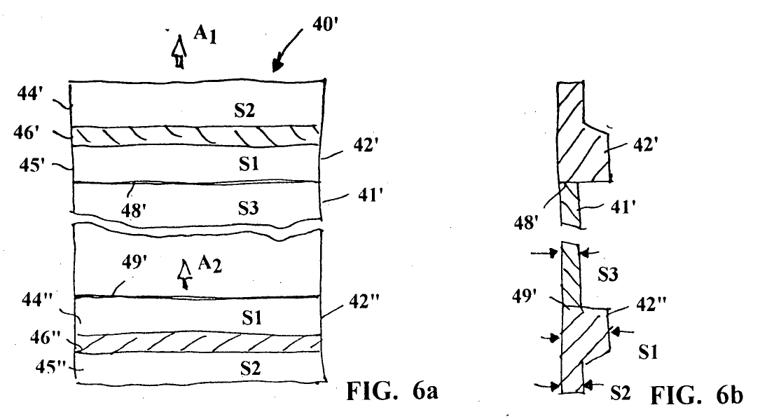

FIGS. 5a and 6a show an inventive sheet metal element 40 which is produced by joining one part 41 with a constant sheet thickness S₁ and one flexibly rolled part 42 with a rolling direction A with portions 44, 45 having different thicknesses S₁, S₂. A region of transition 46 is hatched in the plan view. At the joint provided in the form of a weld 48, there abut different sheet thicknesses comprising a thickness step which, in this form and/or in this size, could not be achieved by flexible rolling alone.

FIGS. 6a and 6b show an inventive sheet metal element 40′ which is produced by joining one part 41′ of a constant thickness S₃ and two flexibly rolled parts 42′, 42″, with the latter each comprising portions 44′, 45′ 44″, 45″ with different thicknesses S₁, S₂. The regions of transition 46′ are hatched in the plan view. The joints are shown as welds 48′, 49′ and extend transversely to the rolling direction A₁, A₂ of the flexibly rolled parts. At the joints, similarly to FIG. 5, there exists a thickness step which, in this form, could not be achieved by flexible rolling. As indicated by an interrupted line, the part 41′ with a constant thickness could be longer relative to the flexibly rolled parts.

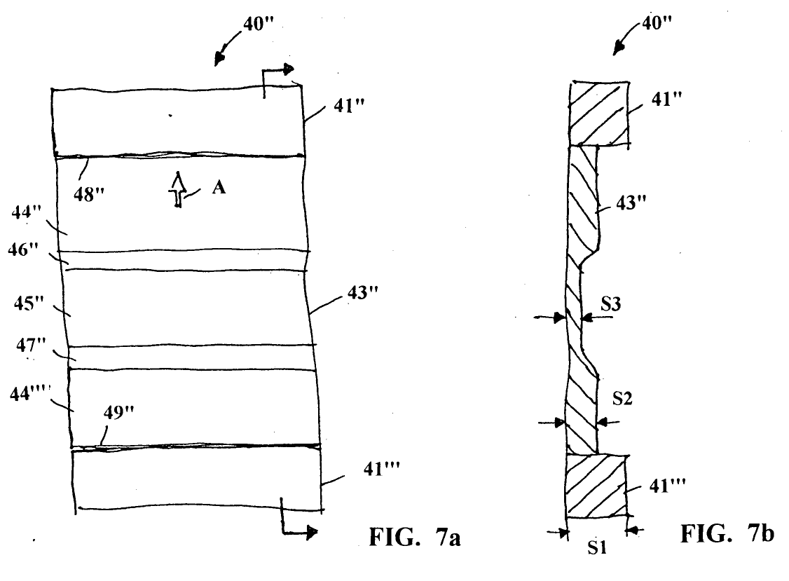

FIGS. 7a and 7b show an inventive sheet metal element 40″ which is produced by joining two parts 41″, 41 ′″ with a constant thickness S₁ and one flexibly rolled part 43″ which comprises portions 44″, 45″, 44′″ of different thicknesses S₁, S₂. The regions of transition 46″, 47″ are hatched in the plan view. The joints are shown as welds 48″, 49″ and extend transversely to the rolling direction A. At the joint, similarly to FIG. 6, there exists a thickness step which could not be achieved by flexible rolling.

The elements according to FIGS. 5 to 7 can be produced by joining parts separated individually from rolled sheet metal; first, there is produced a strip which, after further treatment stages, is divided to form joined sheet metal elements.

In all the embodiments shown in FIGS. 1 to 7, the joints can also extend at an angle relative to the respective rolling directions, so that angles deviating form 0° or 90° can be formed between the rolling direction A and the joints 13, 29, 33, 48, 49.

In all figures, in plan view, illustration a), the metal sheets tend to be shown in a shortened condition, whereas in the cross section, illustration b), the thicknesses S are shown in an exaggerated form relative to the lengths.

The process of joining sheet metal elements according to FIGS. 1 to 7 includes the possibility of using different materials for the parts.

1. A sheet metal element in the form of a semi-finished product, produced by joining at least one part consisting of flexibly rolled sheet metal whose sheet thickness is variable along the rolling direction A and at least one part consisting of a rolled sheet metal with a constant sheet thickness.

2. A sheet metal element in the form of a semi-finished product, produced by joining at least two parts consisting of flexibly rolled sheet metal whose sheet thickness varies along the respective rolling direction A₁, A₂.

3. A sheet metal element according to claims 1 or 2, wherein the joint extends substantially parallel to said rolling direction A, A₁, A₂ along which the sheet thickness of the flexibly rolled sheet metal changes.

4. A sheet metal element according to claims 1 or 2, wherein the joint extends substantially transversely to said rolling direction A, A₁, A₂ along which the sheet thickness of the flexibly rolled sheet metal changes.

5. A sheet metal element according to claims 1 or 2, wherein at least partially differing sheet metal thicknesses meet at the joint).

6. A sheet metal element according to claims 1 or 2, wherein a part consisting of flexibly rolled sheet metal whose sheet thickness varies along the rolling direction A is positioned between two parts consisting of sheet metal with a constant sheet thickness.

7. A sheet metal element according to claims 1 or 2, wherein a part consisting of sheet metal with a constant sheet thickness is positioned between two parts consisting of flexibly rolled sheet metal whose sheet thickness varies in the respective rolling direction A, A₁, A₂.

8. A sheet metal element according to claims 1 or 2, wherein the individual parts are butt-welded.

9. A sheet metal element according to claims 1 or 2, wherein the individual parts are welded so as to overlap.

10. A sheet metal element according to claims 1 or 2, wherein the individual parts are clinched or riveted in an overlapping condition.

11. A sheet metal element according to claims 1 or 2, wherein the individual parts are glued to one another in an overlapping condition.

12. A sheet metal element according to claims 1 or 2, wherein the individual parts are connected to one another by a crimp connection.

13. A method of producing sheet metal elements in the form of semi-finished products, wherein at least one strip of flexibly rolled sheet metal whose sheet thickness varies along the rolling direction A and one strip of rolled sheet metal with a constant sheet thickness are continuously joined parallel to said rolling direction to form a strip and that subsequently, sheet metal elements consisting of at least one part of flexibly rolled strip and at least one part of sheet metal with a constant sheet thickness are separated.

14. A method of producing sheet metal elements in the form of semi-finished products, wherein at least two strips of flexibly rolled sheet metal whose sheet thickness varies along the respective rolling direction A₁, A₂ are joined parallel to said rolling direction to form a strip and that subsequently sheet metal elements consisting of at least two different parts are separated from the strip.

15. A method of producing sheet metal elements in the form of semi-finished products, wherein parts consisting of flexibly rolled sheet metal whose sheet thickness varies along the respective rolling direction A, A₁, A₂ and parts consisting of rolled sheet metal with a constant sheet thickness are alternately continuously joined transversely to said rolling direction to form a strip and that subsequently sheet metal elements consisting of at least one part of flexibly rolled sheet metal and at least one part of sheet metal with a constant sheet thickness are separated.

16. A method according to claim 14, wherein the strips are joined in such a way that different plate thicknesses meet at the joint.

17. A method according to claims 13, 14 or 15, wherein the joint strip is coiled and heat-treated.

18. A method according to claims 13, 14 or 15, wherein the joined strip is surface-treated.

19. A method according to claims 13, 14 or 15, wherein, prior to being separated, the joined strip is deformed to form a profile.

20. A method according to claims 13, 14 or 15, wherein the sheet metal elements are deformed after the strip has been divided.
